(19) United States
(12) Patent Application Publication
(10) Pub. No.: US 2012/0231171 A1
(43) Pub. Date: Sep. 13, 2012

(54) ENHANCED PLANT GROWTH SYSTEM

(76) Inventors: Aicardo Roa-Espinosa, Madison, WI (US); Tomas James Roa-Lauby, Monona, WI (US)

(21) Appl. No.: 13/046,675

(22) Filed: Mar. 11, 2011

(51) Int. Cl. B05D 5/00; C05F 11/00; B05D 3/00; C05D 9/00

(52) U.S. Cl. 427/385.5; 71/27; 71/28

(57) ABSTRACT

A composition for enhancing plant growth and a method of applying the composition onto hydrophobic surfaces and retaining the composition on these surfaces is disclosed. The composition comprises a superabsorbent, a binder and nutrients that may be applied onto surfaces of materials that are part of the plants or plant growth environment such as seeds, soil, mulch, plant roots and herbicides. An aqueous solution of the composition may be applied to the material surfaces through the irrigation system. Once dried, a substantially solid film forms on these surfaces that contains the superabsorbent and the nutrients that are available for the plants to enhance their growth.

### FIELD OF THE INVENTION

The present invention generally relates to a composition and a method of applying the composition onto hydrophobic surfaces and retaining the composition on these surfaces. More specifically, the present invention relates to a composition and a method of applying the composition onto materials that impact plant growth such as plant seeds, soil, plant roots and mulch. The composition coats the material surfaces and helps lock in moisture and nutrients that are beneficial to plant growth.

### BACKGROUND OF THE INVENTION

Plant growth requires the presence of moisture and nutrients in the planted seeds and the soil in which the seeds grow. In arid climates and in areas where water is not sufficiently available for irrigation, plant growth may suffer due to loss of moisture around the seeds. Conversely, excessive rain may cause soil erosion and wash away the fertilizers and nutrients in the soil and around the seeds. It would be therefore be desirable to find a way to lock in moisture and nutrients into the environment in which the plant grows including the soil, plant seeds, plant roots, and mulch so that plant growth is enhanced especially in arid climates as well as climates that experience excessive rain.

A number of US patents disclose compositions for improving fiber absorbency and moisture as well as improving water retention of soil and other agricultural materials.

U.S. Pat. Nos. 6,686,414 and 6,984,419 relate to a crosslinked aqueous solution polymer composition consisting of at least one water soluble monomer, preferably an alpha, beta-ethylenically unsaturated carboxylic acid monomer and a crosslinking agent. The polymer solution is sufficiently low enough in viscosity such that it can be applied in aqueous form, yet after crosslinking possesses a fast rate of acquisition and is high absorption capacity. The invention also relates to new methods of enhancing the absorbency of various articles, increasing the humectancy and/or absorbency of a fiber or fibrous matrix, improving the water retention of soil and other agricultural methods, and increasing the open time of cement by incorporating or applying an aqueous superabsorbent polymer composition.

U.S. Pat. No. 7,438,951 teaches a method of increasing the humectancy of a fiber, comprising: a) applying an aqueous polymer composition on a fiber, the composition comprising a polymer derived from monomers consisting of water soluble .alpha.-.beta.-ethylenically unsaturated carboxylic acid monomers neutralized with a base selected from the group consisting of alkali metal hydroxide, alkaline earth metal hydroxide, and combinations thereof and a crosslinking agent, and b) drying the composition.

U.S. Pat. No. number 7,135,135 discloses a multilayer construction that includes a first layer that includes water sensitive thermoplastic polymer and a second layer disposed on the first layer containing a superabsorbent polymer.

While the composition provided in these prior art references can readily attach onto fibers having hydrophilic surfaces, the attachment resulting from the application of this composition onto substantially hydrophobic surfaces appears to be weaker and therefore susceptible to loss and removal. Fibers having relatively hydrophilic surfaces may include wood fibers present in paper, disposable diapers and feminine hygiene products. Surfaces that are generally hydrophobic in the context of the present invention include soil, seeds, mulch and plant roots.

### SUMMARY OF THE PRESENT INVENTION

The composition of the present invention comprises at least one superabsorbent for retaining moisture on the surfaces of materials onto which the composition is applied. The composition of the present invention further provides for at least one binder component and a nutrient component. The binder helps attach the composition onto the hydrophobic surfaces of the materials in the environment of the plant in order to enhance plant growth. These materials may include seeds, ground soil, potting soil, plant roots, herbicides, mulch made of untreated and treated saw mill residuals, mulch and biomass residuals from processing cotton, animal manure fibers, switch grass, burr plants, wheat, barley, oats, rye, triticale, sorghum, waste paper, hey and Sudan grass. The nutrient component serves as nourishment to the plant.

The application of the composition onto hydrophobic surfaces results in a film bonded to the surfaces. The film contains a binder, at least one superabsorbent and plant nutrients. The superabsorbent is slow to release any moisture it contains and quick to absorb moisture from rain or irrigation.

In another aspect of the present invention, a method of coating surfaces with a composition for enhancing plant growth, the method comprises: providing an aqueous solution containing at least one superabsorbent polymer, a binder, a cross linking agent and at least one plant nutrient; providing materials in the plant growth environment, the materials having substantially hydrophobic surfaces; applying the aqueous solution onto the surfaces of the materials; removing water from the aqueous solution; and forming a substantially solid film on the surfaces.

These and other features, aspects and advantages of the present invention will become better understood with reference to the following drawings, description and claims.

### DETAILED DESCRIPTION OF THE PRESENT INVENTION

The preferred superabsorbent polymer of the present invention is prepared by reacting an ethylenically unsaturated carboxylic acid monomer neutralized with an alkali metal hydroxide to a pH of at least 7 with a crosslinking agent. The monomer is selected from the group consisting of acrylic acid, methacrylic acid, crotonic acid, maleic acid, maleic acid anhydride, itaconic acid, fumaric acid and combinations thereof. The preferred crosslinking agent of the present invention comprises ammonium zirconium carbonate.

The preferred binders of the present invention comprise urea having a chemical formula of CO(NH₂)₂ , pregelatinized starch and ethylenediamine having a chemical formula of C₂H₄(NH₂)₂.

The nutrient component of the composition may comprise of mineral source nutrients and carbohydrate source nutrients.

Exemplary embodiments for the mineral source nutrient component of the composition may include urea compounds, anhydrous ammonia, nitrate salts, phosphate salts, ammonium salts and mixtures thereof. The cationic component of the nitrate salts that fall within the scope of the present invention may comprise of sodium, potassium or calcium for which the corresponding salt has a chemical formula of Ca(NO₃)₂.

Urea compounds that fall within the scope of the present invention include urea having a chemical formula of CO(NH₂)₂, urea sulfate CH₄N₂O.H₂O₄S, urea ammonium nitrate having a chemical formula of NH₄NO3+CO(NH₂)₂+H2O, urea ammonium phosphate CO(NH2)-NH3-H3PO4-H2O, and urea phosphate CO(NH₂)₂H₃PO₄.

Phosphate salts that fall within the scope of the present invention include ammonium chloride, ammonium nitrate, ammonium sulfate, Mono-ammonium phosphate, Diammonium phosphate, Ammonium phosphate-sulfate, Ammonium polyphosphate

The ammonium salt mineral source nutrients that fall within the context of the present invention include ammonium chloride NH₄Cl, ammonium nitrate NH₄NO₃, ammonium sulfate (NH₄)₂SO₄, mono-ammonium phosphate NH₄H₂PO₄, ammonium thiosulfate H₈N₂O₃S₂, diammonium phosphate (NH₄)₂HPO₄, ammonium phosphate-sulfate (NH₄)₂(H₂PO₄)(HSO₄) and ammonium polyphosphate (NH4PO₃)ₙ.

Generally, the cationic component of the mineral source nutrients may include ammonium, calcium, urea, sodium, ferrous cation, ferric cation, manganese, copper, zinc and molybdenum. The complementary anionic components of the mineral source nutrients may include phosphate, sulfate, chloride, thiosulfate, carbonate, hydroxide, acetate, chelate, oxide, nitrate and sulfide. Additional mineral source nutrients that fall within the scope of the present invention include urea, ammonia, sulfur, citric acid, boric acid, oxalic acid, acetic acid, phosphoric acid and mixtures thereof.

The preferred carbohydrate source nutrient contains oligosaccharides. Examples of oligosaccharides that fall within the scope of the present invention include, but are not limited to, disaccharides, such as sucrose and lactose, trisaccharide raffinose and tetrasaccharide stachyose. The chemical formula of unmodified disaccharides is C₁₂H₂₂O₁₁.

The method of preparation of the composition for coating the surfaces comprises the steps of:

1. Preparing an aqueous monomer solution at a concentration between about 10% to about 25%;

2. Raising the pH of the monomer to at least 7;

3. Blending a crosslinking agent with the monomer solution at between about 2% to about 10% by weight of the active monomer solution, and preferably about 5%;

4. Blending a binder with the monomer solution at between about 5% to about 15% by weight of the active monomer solution;

5. Blending in at least one mineral source nutrient component at between about 5 ppm to about 50 ppm by weight of the active monomer solution; and

6. Blending at least one carbohydrate source nutrient component at between about 5 ppm to about 50 ppm by weight of the active monomer solution.

The method for binding the composition onto hydrophobic surfaces comprises 1) applying an aqueous solution onto these surfaces, 2) removing water from the composition to achieve percent solids of between about 5% to about 20%, and 3) forming a film bound to these surfaces. The application of the aqueous solution may be accomplished by spraying using an irrigation system. Alternatively, the solution may be applied on some materials such as seeds by soaking Water may be removed by allowing the aqueous solution on the surfaces to dry under ambient conditions or by applying heat to expedite the drying.

The scope of the present invention further comprises treating fibers present in the plant environment, such as mulch, to reduce their surface hydrophobicity to further improve binding strength of the composition onto their surfaces. A process for reducing the hydrophobicity of fiber surfaces may be accomplished by treating the fibers and fiber bundles to reduce lignin and hemicelluloses content of these fibers. In an embodiment of the present invention the process comprises the substantially simultaneous steps of:
macerating the fibers;
removing at least a portion of the lignin from the fibers;
softening the fibers; and
swelling the fibers.

A treatment apparatus for accomplishing these steps may comprise of a closed chamber adapted for use under pressure. The chamber has a longitudinal central axis, a cylindrical enclosure and a feed opening configured with a fiber feeding device. The inner chamber walls comprise a plurality of channels. A shaft disposed along the longitudinal central axis of said chamber, is configured for rotation around the central axis. A plurality of pins is affixed and configured to protrude from the central axis in a substantially perpendicular relation to the central axis and define a tight clearance with the chamber walls.

The fibers fed into the apparatus are chemically treated in the gas phase with a gaseous mixture containing steam, ammonia and ethylenediamine at a temperature of between about 140 degrees C. and about 180 degrees C. and a pressure of about 2 kilopascals gauge. As the fibers are fed into the chamber, they are chemically softened and macerated in the tight clearance between the pins and chamber walls. The treatment partially dissolves and removes hemi-cellulose and lignin fragments from the cell wall which exposes the more hydrophilic layers of the cellulose components in the fibers.

FTIR data on the films bonded to material surfaces indicates that the superabsorbent polymer, the binder and the nutrients present in the original solution are preserved in the film. This suggests that the bonding of the components is effective.

### EXAMPLES

### Example 1

Composition of the Aqueous Solution:

Monomer: PD8081H from HB Fuller making up about 80% of the active solids neutralized with potassium hydroxide.

Crosslinking agent: BACOTE 20® at a making up about 7% of the active solids.

Binder: Ethylenediamine making up about 10% of the active solids.

Aqueous solution concentration is about 14%.

Mineral nutrients: 15 ppm Diammonium phosphate, 10 ppm Magnesium sulfate and 5 ppm Zinc carbonate.

Carbohydrate nutrient: 40 ppm of sucrose. pH: 8.5

Viscosity: 850 cps.

Composition of Film Applied onto Surfaces of Materials in the Plant Environment:

Material: Plant seeds

Absorbency: 70 g water/gram of composition

FTIR data indicate peaks consistent with the presence of the ethylenediamine, ammonium zirconium carbonate, and sucrose.

### Example 2

Composition of the Aqueous Solution:

Monomer: PD8081H from HB Fuller making up about 80% of the active solids neutralized with potassium hydroxide.

Crosslinking agent: BACOTE 20® at a making up about 7% of the active solids.

Binder: Urea making up about 10% of the active solids.

Aqueous solution concentration is about 10%.

Mineral nutrients: 25 ppm Copper acetate, 15 ppm Molybdenum trioxide and 5 ppm Manganese chloride.

Carbohydrate nutrient: 40 ppm of lactose.

pH: 8.0

Viscosity: 700 cps.

Composition of Film Applied onto Surfaces of Materials in the Plant Environment:

Material: untreated mulch

Absorbency: 40 g water/gram of composition

FTIR data indicate peaks consistent with the presence of the urea, ammonium zirconium carbonate, and lactose.

### Example 3

A germination rate study was conducted by the University of Wisconsin, Green Bay using a composition embodiment consistent with the present invention. A composition comprising a superabsorbent polymer and urea was applied onto perennial rye seeds (PRG) and the germination rates were compared with those of uncoated seeds and those of seeds coated with a composition comprising a superabsorbent polymer only.

The superabsorbent polymer solution was prepared at a concentration of about 15% from PD8081H obtained from HB Fuller in a manner described in the Specification section. This is denoted as PRG/LXL in the results table below. PRG/LXL+urea denotes the superabsorbent polymer solution prepared in the same manner and containing 7% urea based on the active monomer present in the solution.

For the purpose of this example, the urea acts as both the binder and nutrient.

After germination began, seedlings were watered once a day. Humidity varied throughout the experiment. In the first 7 days, the humidity varied from about 0% to about 16% and around 40% thereafter.

The table below shows seedling counts from the day the germination started and represents averages of duplicate readings. The results indicate an increase in the germination counts for the urea containing composition relative to the composition containing only superabsorbent polymer of about 64%, 12% and 9% for 6 days, 11 days and 16 days respectively. The improvement in germination rates performance for the composition containing urea compared to the composition comprising only a superabsorbent polymer appears to be more pronounced at low humidity levels that were prevalent during the first week of the experiments. This indicates that adding a binder and nutrient makes the composition more effective in arid climates where humidity levels tend to be low.

| Sample | Day 6 | Day 11 | Day 16 |
|---|---|---|---|
| PRG Uncoated | 11.5 | 207 | 277 |
| PRG/LXL | 11 | 225 | 268 |
| PRG/LXL + Urea | 18 | 251 | 291 |

I claim:

1. A composition for attaching chemicals that aid in plant growth onto hydrophobic surfaces, said composition comprising:
at least one superabsorbent polymer for absorbing and retaining water;
at least one plant nutrient; and
at least one binder to enhance attachment of the superabsorbent polymer and nutrients onto said hydrophobic surfaces.

2. The composition of claim 1, wherein the superabsorbent is made from an ethylenically unsaturated carboxylic acid monomer selected from the group consisting of methacrylic acid, acrylic acid, crotonic acid, maleic acid, maleic acid anhydride, itaconic acid, fumaric acid and combinations thereof, said monomers being reacted with an alkali metal to a pH of at least 7, said monomer being further reacted with a crosslinking agent.

3. The composition of claim 2, wherein the alkali metal is selected from the group consisting of potassium, sodium, magnesium, calcium and combinations thereof.

4. The composition of claim 2, wherein the crosslinking agent comprises ammonium zirconium carbonate.

5. The composition of claim 1, wherein the binder comprises a compound selected from the group consisting of urea, pre-gelatinized starch, ethylenediamine and combinations thereof.

6. The composition of claim 2, wherein the plant nutrient comprises at least one mineral source nutrient.

7. The composition of claim 6, wherein the mineral source nutrient contains a cationic component and an anionic component.

8. The composition of claim 7, wherein the cationic component is selected from the group consisting of ammonium, calcium, urea, sodium, ferrous cation, ferric cation, manganese, copper, zinc and molybdenum.

9. The composition of claim 7, wherein the anionic component is selected from the list consisting of phosphate, sulfate, chloride, thiosulfate, carbonate, hydroxide, acetate, chelate, oxide, nitrate and sulfide.

10. The composition of claim 6, wherein the mineral source nutrient is selected from the group consisting of urea, ammonia, sulfur, citric acid, boric acid, oxalic acid, acetic acid, phosphoric acid and mixtures thereof.

11. The composition of claim 1, wherein the plant nutrient further comprises at least one carbohydrate source nutrient.

12. The composition of claim 11, wherein the carbohydrate source nutrient comprises oligosaccharides.

13. A method of coating surfaces with a composition for enhancing plant growth, said method comprising:
providing an aqueous solution containing at least one superabsorbent polymer, a binder, a cross linking agent and at least one plant nutrient;
providing materials in the plant growth environment, said materials having substantially hydrophobic surfaces;
applying the aqueous solution onto the surfaces of said materials;
removing water from the aqueous solution; and
forming a substantially solid film on said surfaces.

14. The method of claim 13, wherein providing the aqueous solution containing at least one superabsorbent polymer, a binder, a cross linking agent and at least one plant nutrient comprises:
preparing an aqueous monomer solution at a concentration between about 10% to about 25%, said monomer being selected from the group consisting of methacrylic acid, acrylic acid, crotonic acid, maleic acid, maleic acid anhydride, itaconic acid, fumaric acid and combinations thereof;
blending an alkaline metal with the aqueous monomer solution to raise a pH of the solution to at least 7.0;
blending a crosslinking agent with the monomer solution at between about 2% to about 10% by weight of the active monomer solution, said crosslinking agent comprising ammonium zirconium carbonate;
blending a binder at between about 5% to about 15% by weight of the active monomer solution with the aqueous monomer solution, said binder being selected from the group consisting of urea, pre-gelatinized starch, ethylenediamine and combinations thereof;
blending in at least one mineral source nutrient component at between about 5 ppm to about 50 ppm by weight of the active monomer solution; and
blending at least one carbohydrate source nutrient component at between about 5 ppm to about 50 ppm by weight of the active monomer solution.

15. The method of claim 13, wherein the materials in the plant growth environment comprise fibrous components.

16. The method of claim 15, wherein the process for reducing hydrophobicity from the fibrous components of the materials comprises:
feeding said fibrous components into a treatment chamber adapted for use under pressure, said treatment chamber comprising a longitudinal central axis, a cylindrical enclosure and inner chamber walls containing a plurality of channels, said treatment chamber further comprising: a shaft disposed along the longitudinal central axis of said chamber, said shaft being configured for rotation around the central axis and a plurality of pins affixed and configured to protrude from the central axis in a substantially perpendicular relation to the central axis such that said pins define a tight clearance with the chamber walls;
treating said fibrous components with a gaseous mixture containing steam, ammonia and ethylenediamine at a temperature of between about 140 degrees C. and about 180 degrees C. and a pressure of about 2 kilopascals gauge; and
macerating said fibers inside said channels;

17. The method of claim 13, wherein the materials in the plant growth environment comprise plant seeds.

18. The method of claim 13, wherein the materials in the plant growth environment comprise plant soil.

19. The method of claim 13, wherein the materials in the plant growth environment comprise plant roots.
